(19) United States
(12) Patent Application Publication
(10) Pub. No.: US 2024/0306031 A1
(43) Pub. Date: Sep. 12, 2024

(54) METHOD FOR DATA TRAFFIC CORRELATION AND TRANSMISSION

(71) Applicant: ZTE CORPORATION, Shenzhen (CN)

(72) Inventors: Zhijun LI, Shenzhen (CN); Jinguo ZHU, Shenzhen (CN); Menghan WANG, Shenzhen (CN)

(73) Assignee: ZTE CORPORATION, Shenzhen (CN)

(21) Appl. No.: 18/604,177

(22) Filed: Mar. 13, 2024

Related U.S. Application Data
(63) Continuation of application No. PCT/CN2021/143807, filed on Dec. 31, 2021.

(51) Int. Cl. H04W 28/02

(52) U.S. Cl. CPC H04W 28/0268

(57) ABSTRACT

A wireless communication method for use in a first wireless network node is disclosed. The method comprises transmitting, to a second wireless network node, a packet in one of a plurality of quality of service, QoS, flows associated with an application data unit, wherein a packet header of the packet comprises traffic correlation information associated with the application data unit.

### CROSS-REFERENCE TO RELATED PATENT APPLICATIONS

This application is a Continuation of PCT Application No. PCT/CN2021/143807, filed Dec. 31, 2021, incorporated herein by reference in its entirety.

### TECHNICAL FIELD

This document is directed generally to wireless communications, and in particular to 5^{th} generation (5G) communications.

### BACKGROUND

In a 5G network, internet protocol (IP) traffic transmitted from/to a user equipment (UE) is configured at per quality-of-service (QOS) flow level. During a protocol data unit (PDU) session establishment procedure, the 5G network may assign specific QoS flow(s) for an application requested by the UE.

### SUMMARY

In addition, a QoS model is based on the QoS Flows. The 5G QoS model supports both QoS Flows that require guaranteed flow bit rate (i.e., GBR QOS Flows) and QoS Flows that do not require guaranteed flow bit rate (i.e., Non-GBR QoS Flows).

The QoS Flow is the finest granularity of QoS differentiation in the PDU Session. User Plane traffic with the same QoS flow identifier (QFI) within a PDU Session have the same traffic forwarding treatments (e.g., scheduling, admission threshold). The QFI is carried in an encapsulation header of each GTP-U packets on N3/N9 interface, as in an end-to-end (E2E) GTP-U packet header. The QFI is used for all types of the PDU Session.

Single QoS Flow is identified by one QFI and associated with QoS requirements specified by QoS parameters and QOS characteristics. The QFI for each QoS flow is unique within one PDU Session. The QFI may be dynamically assigned or may be equal to a pre-configured 5G QoS Identifier (5Q1) value.

During the PDU session establishment, a default QoS flow is required to be established for the PDU session and remains established throughout the lifetime of the PDU session. The default QoS Flow may be a Non-GBR QoS Flow.

Within a 5G system (5GS), the QoS Flow is controlled by a session management function (SMF) and may be preconfigured or established via a PDU Session Establishment procedure or via a PDU Session Modification procedure.

The existing QoS model supports normal IP communications (e.g., the IP traffic transmission between the UE and an Application Server (AS)). However, the existing QoS model may not be able to fully support IP communications for Extended Reality (XR) services, such as Augmented Reality (AR) services, Virtual Reality (VR) services and Mixed Reality (MR) services.

For instance, the XR service may require several dedicated QoS flows for related IP transmissions, to support audio traffic, video traffic, traffic of six degrees of freedom (6 DoF) sensors, etc. Based on the requirements of the XR service, the XR traffic on different QoS flows may need to be highly time synchronized. However, such service requirements cannot be guaranteed by the existing 5G QoS model, since the existing 5G QoS model does not guarantee synchronization among traffic belonging to different QoS flows.

This document relates to methods, systems, and devices for supporting the XR services, in particular to methods, systems, and devices for binding and handling traffic on different QoS flows.

The present disclosure relates to a wireless communication method for use in a first wireless network node. The method comprises:
transmitting, to a second wireless network node, a packet in one of a plurality of quality of service, QoS, flows associated with an application data unit, wherein a packet header of the packet comprises traffic correlation information associated with the application data unit.

Various embodiments may preferably implement the following features:

Preferably or in some embodiments, the traffic correlation information comprises a traffic correlation identifier of the application data unit.

Preferably or in some embodiments, the traffic correlation identifier indicates at least one of: a correlation policy identifier associated with a correlation policy applied on the plurality of QoS flows, an application data unit type associated with a type of the application data unit, an application type associated with a type of an application to which the packet belongs, or an application identifier associated with the application to which the packet belongs.

Preferably or in some embodiments, the traffic correlation information comprises information associated with at least one of: a sequence number of the application data unit, a size of the application data unit, an importance level of the packet in the application data unit, or a duplication number of the application data unit.

Preferably or in some embodiments, the first wireless network node is one of a user plane function and a radio access network node.

Preferably or in some embodiments, the packet is a general packet radio service tunneling protocol user plane, GTP-U, packet and the packet header is a GTP-U header.

The present disclosure relates to a wireless communication method for use in a second wireless network node. The method comprises:
receiving, from a first wireless network node, a packet in one of a plurality of quality of service, QoS, flows associated with an application data unit, wherein a packet header of the packet comprises traffic correlation information associated with the application data unit, and
performing a correlation action on the packet based on the traffic correlation information.

Various embodiments may preferably implement the following features:

Preferably or in some embodiments, the traffic correlation information comprises a traffic correlation identifier of the application data unit.

Preferably or in some embodiments, wherein the traffic correlation identifier indicates at least one of: a correlation policy identifier associated with a correlation policy applied on the plurality of QoS flows, an application data unit type associated with a type of the application data unit, an application type associated with a type of an application to which the packet belongs, or an application identifier associated with the application to which the packet belongs.

Preferably or in some embodiments, the traffic correlation information comprises information associated with at least one of: a sequence number of the application data unit, a size of the application data unit, an importance level of the packet in the application data unit, or a duplication number of the application data unit.

Preferably or in some embodiments, the second wireless network node is one of a user plane function and a radio access network node.

Preferably or in some embodiments, the packet is a general packet radio service tunneling protocol user plane, GTP-U, packet and the packet header is a GTP-U header.

Preferably or in some embodiments, performing the correlation action on the packet based on the traffic correlation information comprises associating the packet with the application data unit based on the traffic correlation information.

Preferably or in some embodiments, performing the correlation action on the packet based on the traffic correlation information comprises applying a correlation policy associated with the application data unit based on the traffic correlation information.

Preferably or in some embodiments, performing the correlation action on the packet based on the traffic correlation information comprises acquiring at least one measurement result of the application data unit based on the traffic correlation information.

Preferably or in some embodiments, the at least one measurement result comprises at least one of: an average packet delay of the plurality of QoS flows, a deviation of packet delay of the plurality of QoS flows, an average packet loss rate of the plurality of QoS flows, a deviation of packet loss rate of the plurality of QoS flows, or an un-synchronization rate among transmissions of packets which belong to the same application data unit and are on different QoS flows.

Preferably or in some embodiments, performing the correlation action on the packet based on the traffic correlation information comprises reporting at least one QoS event associated with the application data unit.

The present disclosure relates to a wireless communication method for use in a wireless network node. The method comprises:
receiving, from a session management function, a traffic correlation policy associated with an application data unit, and
applying the traffic correlation policy on a plurality of quality of service, QoS, flows associated with the application data unit.

Various embodiments may preferably implement the following features:

Preferably or in some embodiments, the traffic correlation policy comprises at least one of: a correlation policy identifier, a list of QOS flows, a list of QoS monitoring actions, a list of event report thresholds, or a list of event report triggers.

Preferably or in some embodiments, the list of QoS monitoring actions comprises at least one of: monitoring a packet delay of the plurality of QoS flows, monitoring a packet loss rate of the plurality of QoS flows, or monitoring an un-synchronization rate among transmissions of packets which belong to the same application data unit and are on different QoS flows.

Preferably or in some embodiments, the list of event report thresholds is associated with at least one of: an average packet delay of the plurality of QoS flows, a deviation of packet delay of the plurality of QoS flows, an average packet loss rate of the plurality of QoS flows, a deviation of packet loss rate of the plurality of QoS flows, or an un-synchronization rate among transmissions of packets which belong to the same application data unit and are on different QoS flows.

Preferably or in some embodiments, the list of event report triggers comprises reporting at least one of: an average packet delay of the plurality of QoS flows, a deviation of packet delay of the plurality of QoS flows, an average packet loss rate of the plurality of QoS flows, a deviation of packet loss rate of the plurality of QoS flows, or an un-synchronization rate among transmissions of packets which belong to the same application data unit and are on different QoS flows.

Preferably or in some embodiments, the wireless network node is one of a user plane function and a radio access network node.

The present disclosure relates to a wireless communication method for use in a session management function. The method comprises:
transmitting, to a wireless network node, a traffic correlation policy associated with an application data unit, wherein the traffic correlation policy is applied on a plurality of quality of service, QoS, flows associated with the application data unit.

Various embodiments may preferably implement the following features:

Preferably or in some embodiments, the traffic correlation policy comprises at least one of: a correlation policy identifier, a list of QOS flows, a list of QoS monitoring actions, a list of event report thresholds, or a list of event report triggers.

Preferably or in some embodiments, the list of QoS monitoring actions comprises at least one of: monitoring a packet delay of the plurality of QoS flows, monitoring a packet loss rate of the plurality of QoS flows, or monitoring an un-synchronization rate among transmissions of packets which belong to the same application data unit and are on different QoS flows.

Preferably or in some embodiments, the list of event report thresholds is associated with at least one of: an average packet delay of the plurality of QoS flows, a deviation of packet delay of the plurality of QoS flows, an average packet loss rate of the plurality of QoS flows, a deviation of packet loss rate of the plurality of QoS flows, or an un-synchronization rate among transmissions of packets which belong to the same application data unit and are on different QoS flows.

Preferably or in some embodiments, the list of event report triggers comprises reporting at least one of: an average packet delay of the plurality of QoS flows, a deviation of packet delay of the plurality of QoS flows, an average packet loss rate of the plurality of QoS flows, a deviation of packet loss rate of the plurality of QoS flows, or an un-synchronization rate among transmissions of packets which belong to the same application data unit and are on different QoS flows.

Preferably or in some embodiments, the wireless network node is one of a user plane function and a radio access network node.

Preferably or in some embodiments, the wireless communication method further comprises:
transmitting, to a policy control function, a policy association related request, and
receiving, from the policy control function, the traffic correlation policy.

The present disclosure relates to a wireless communication method for use in a policy control function. The method comprises:
receiving, from a session management function, a policy association related request, and
transmitting, to the session management function, a traffic correlation policy associated with an application data unit.

Various embodiments may preferably implement the following features:

Preferably or in some embodiments, the traffic correlation policy comprises at least one of: a correlation policy identifier, a list of QoS flows, a list of QoS monitoring actions, a list of event report thresholds, or a list of event report triggers.

Preferably or in some embodiments, the list of QoS monitoring actions comprises at least one of: monitoring a packet delay of the plurality of QoS flows, monitoring a packet loss rate of the plurality of QoS flows, or monitoring an un-synchronization rate among transmissions of packets which belong to the same application data unit and are on different QoS flows.

Preferably or in some embodiments, the list of event report thresholds is associated with at least one of: an average packet delay of the plurality of QoS flows, a deviation of packet delay of the plurality of QoS flows, an average packet loss rate of the plurality of QoS flows, a deviation of packet loss rate of the plurality of QoS flows, or an un-synchronization rate among transmissions of packets which belong to the same application data unit and are on different QoS flows.

Preferably or in some embodiments, the list of event report triggers comprises reporting at least one of: an average packet delay of the plurality of QoS flows, a deviation of packet delay of the plurality of QoS flows, an average packet loss rate of the plurality of QoS flows, a deviation of packet loss rate of the plurality of QoS flows, or an un-synchronization rate among transmissions of packets which belong to the same application data unit and are on different QoS flows.

The present disclosure relates to a wireless communication method for use in a wireless network node. The method comprises:
receiving, from a session management function, traffic characteristic information of an application data unit transmission, and
recognizing at least one application data unit in the application data unit transmission based on the traffic characteristic information,
wherein each application data unit comprises packets on a plurality of quality of service, QoS, flows.

Various embodiments may preferably implement the following features:

Preferably or in some embodiments, the traffic characteristic information comprises at least one of: a list of QoS flows, at least one precentor QoS flow identifier associated with at least one precentor QoS flow on which the first data block in the application data unit transmission is transmitted, a precentor transmission pattern of the first data block transmitted on the at least one precentor QoS flow, a maximum size of single application data unit in the application data unit transmission, a maximum duration of the application data unit transmission, or an application data unit transmission pattern of the application data unit transmission.

Preferably or in some embodiments, the application data unit transmission pattern comprises at least one of: a duration of the application data unit transmission, a size of single application data unit in the application data unit transmission, or an interval between two subsequent application data units in the application data unit transmission.

Preferably or in some embodiments, the wireless communication method further comprises at least one of: transmitting a packet of one of the at least one application data unit, wherein a header of the packet comprises traffic correlation information associated with the application data unit to which the packet belongs, applying a traffic correlation polity on the application data unit transmission, acquiring at least one measurement result associated with the application data unit transmission, monitoring at least one QoS measurement result associated with the application data unit transmission, or reporting at least one QoS event associated with the application data unit transmission.

Preferably or in some embodiments, the wireless network node comprises a radio access network node or a user plane function.

The present disclosure relates to a wireless communication method for use in a session management function. The method comprises:
transmitting, to a wireless network node, traffic characteristic information of an application data unit transmission, wherein the traffic characteristic information is used to recognize at least one application data unit in the application data unit transmission, and each application data unit comprises packets on a plurality of quality of service, QoS, flows.

Various embodiments may preferably implement the following features:

Preferably or in some embodiments, the traffic characteristic information comprises at least one of: a list of QoS flows, at least one precentor QoS flow identifier associated with at least one precentor QoS flow on which the first data block in the application data unit transmission is transmitted, a precentor transmission pattern of the first data block transmitted on the at least one precentor QoS flow, a maximum size of single application data unit in the application data unit transmission, a maximum duration of the application data unit transmission, or an application data unit transmission pattern of the application data unit transmission.

Preferably or in some embodiments, the application data unit transmission pattern comprises at least one of: a duration of the application data unit transmission, a size of single application data unit in the application data unit transmission, or an interval between two subsequent application data units in the application data unit transmission.

Preferably or in some embodiments, the wireless network node comprises a radio access network node or a user plane function.

Preferably or in some embodiments, the wireless communication method further comprises:
transmitting, to a policy control function, a policy association related request, and
receiving, from the policy control function, the characteristic information.

The present disclosure relates to a wireless communication method for use in a policy control function. The method comprises:
receiving from a session management function, a policy association related request, and
transmitting, to the session management function, traffic characteristic information of an application data unit transmission,
wherein the traffic characteristic information is used to recognize at least one application data unit in the application data unit transmission, and
wherein each application data unit comprises packets on a plurality of quality of service, QoS, flows.

Various embodiments may preferably implement the following features:

Preferably or in some embodiments, the traffic characteristic information comprises at least one of: a list of QoS flows, at least one precentor QoS flow identifier associated with at least one precentor QoS flow on which the first data block in the application data unit transmission is transmitted, a precentor transmission pattern of the first data block transmitted on the at least one precentor QoS flow, a maximum size of single application data unit in the application data unit transmission, a maximum duration of the application data unit transmission, or an application data unit transmission pattern of the application data unit transmission.

Preferably or in some embodiments, the application data unit transmission pattern comprises at least one of: a duration of the application data unit transmission, a size of single application data unit in the application data unit transmission, or an interval between two subsequent application data units in the application data unit transmission.

The present disclosure relates to a first wireless network node. The first wireless network node comprises:
a communication unit, configured to transmit, to a second wireless network node, a packet in one of a plurality of quality of service, QoS, flows associated with an application data unit, wherein a packet header of the packet comprises traffic correlation information associated with the application data unit.

Various embodiments may preferably implement the following feature:

Preferably or in some embodiments, the first wireless network node further comprises a processor configured to perform any of the aforementioned wireless communication methods.

The present disclosure relates to a second wireless network node. The second wireless network node comprises:
a communication unit, configured to receive, from a first wireless network node, a packet in one of a plurality of quality of service, QoS, flows associated with an application data unit, wherein a packet header of the packet comprises traffic correlation information associated with the application data unit, and
a processor, configured to perform a correlation action on the packet based on the traffic correlation information.

Various embodiments may preferably implement the following feature:

Preferably or in some embodiments, the processor is further configured to perform any of the aforementioned wireless communication methods.

The present disclosure relates to a wireless network node. The wireless network node comprises:
a communication unit, configured to receive, from a session management function, a traffic correlation policy associated with an application data unit, and
a processor, configured to apply the traffic correlation policy on a plurality of quality of service, QoS, flows associated with the application data unit.

Various embodiments may preferably implement the following feature:

Preferably or in some embodiments, the processor is further configured to perform any of the aforementioned wireless communication methods.

The present disclosure relates to a session management function. The wireless device comprises:
a communication unit, configured to transmit, to a wireless network node, a traffic correlation policy associated with an application data unit, wherein the traffic correlation policy is applied on a plurality of quality of service, QoS, flows associated with the application data unit.

Various embodiments may preferably implement the following feature:

Preferably or in some embodiments, the wireless device further comprises a processor configured to perform any of the aforementioned wireless communication methods.

The present disclosure relates to a wireless device with a policy control function. The wireless device comprises:
a communication unit, configured to:
receive, from a session management function, a policy association related request, and
transmit, to the session management function, a traffic correlation policy associated with an application data unit.

Preferably or in some embodiments, the wireless device further comprises a processor configured to perform any of the aforementioned wireless communication methods.

The present disclosure relates to a wireless network node. The wireless network node comprises:
a communication unit, configured to receive, from a session management function, traffic characteristic information of an application data unit transmission, and
a processor, configured to recognize at least one application data unit in the application data unit transmission based on the traffic characteristic information,
wherein each application data unit comprises packets on a plurality of quality of service, QoS, flows.

Various embodiments may preferably implement the following feature:

Preferably or in some embodiments, the processor is further configured to perform any of the aforementioned wireless communication methods.

The present disclosure relates to a wireless device with a session management function. The wireless device comprises:
a communication unit, configured to transmit, to a wireless network node, traffic characteristic information of an application data unit transmission, wherein the traffic characteristic information is used to recognize at least one application data unit in the application data unit transmission, and wherein each application data unit comprises packets on a plurality of quality of service, QoS, flows.

Various embodiments may preferably implement the following feature:

Preferably or in some embodiments, the wireless device further comprises a processor configured to perform any of the aforementioned wireless communication methods.

The present disclosure relates to wireless device with a policy control function. The wireless device comprises:
a communication unit, configured to:
receive from a session management function, a policy association related request, and
transmit, to the session management function, traffic characteristic information of an application data unit transmission, wherein the traffic characteristic information is used to recognize at least one application data unit in the application data unit transmission, and wherein each application data unit comprises packets on a plurality of quality of service, QoS, flows.

Various embodiments may preferably implement the following feature:

Preferably or in some embodiments, the wireless device further comprises a processor configured to perform any of the aforementioned wireless communication methods.

The present disclosure relates to a computer program product comprising a computer-readable program medium code stored thereupon, the code, when executed by a processor, causing the processor to implement a wireless communication method recited in any one of foregoing methods.

The example embodiments disclosed herein are directed to providing features that will become readily apparent by reference to the following description when taken in conjunction with the accompany drawings. In accordance with various embodiments, example systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the example embodiments and applications described and illustrated herein. Additionally, the specific order and/or hierarchy of steps in the methods disclosed herein are merely example approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The above and other aspects and their implementations are described in greater detail in the drawings, the descriptions, and the claims.

### BRIEF DESCRIPTION OF THE DRAWINGS

FIG. 1 shows a schematic diagram of a network according to an embodiment of the present disclosure.

FIG. 2 shows a schematic diagram of a PDU Session Establishment procedure according to an embodiment of the present disclosure.

FIG. 3 shows a schematic diagram of 5G data traffic according to an embodiment of the present disclosure.

FIG. 4 shows schematic diagram of 5G data traffic according to an embodiment of the present disclosure.

FIG. 5 shows schematic diagram of 5G data traffic according to an embodiment of the present disclosure.

FIG. 6 shows schematic diagram of a procedure according to an embodiment of the present disclosure.

FIG. 7 shows schematic diagram of a procedure according to an embodiment of the present disclosure.

FIG. 8 shows an example of a schematic diagram of a wireless terminal according to an embodiment of the present disclosure.

FIG. 9 shows an example of a schematic diagram of a wireless network node according to an embodiment of the present disclosure.

FIGS. 10 to 17 show flowcharts of methods according to embodiments of the present disclosure.

### DETAILED DESCRIPTION

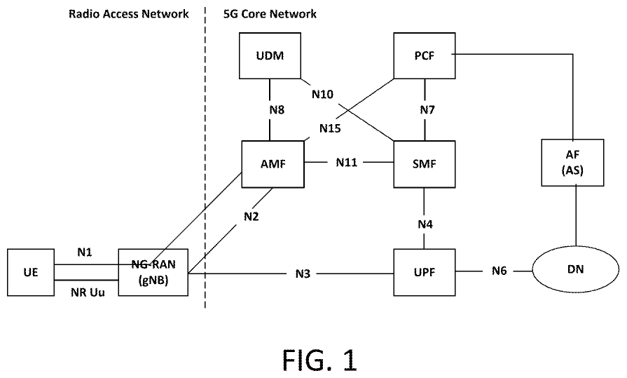

FIG. 1 shows a schematic diagram of a network (architecture) according to an embodiment of the present disclosure. In FIG. 1, the network comprises the following network functions/entities:
1) User Equipment (UE): The UE corresponds to a mobile terminal accessing the network.
2) Next Generation Radio Access Network (NG-RAN):

In the 5G network, the NG-RAN is a new radio (NR) base station, also named gNB. In the present disclosure, the NG-RAN may be equal to NG-RAN node, RAN, or RAN node.
3) Access and Mobility Management function (AMF):

The AMF provides access management and mobility management for the UE, e.g., registration to network, registration during UE mobility, etc.
4) Session Management Function (SMF):

The SMF provides PDU session management for the UE, e.g., IP address allocation, QoS flow setup, etc.
5) User plane function (UPF):

The UPF provides IP traffic routing and forwarding management.
6) Policy Control Function (PCF):

The PCF provides QoS policy rules to control plane functions, to enforce the QoS Policy rules.
7) Application Function (AF):

The AF provides instructions of influencing the QoS policy rules to the PCF. In the present disclosure, the AF may be equal to an Application Server (AS).

After the UE registers to the 5G network, the UE may request a PDU Session Establishment procedure towards the 5G network if requiring communications with an Application Server. During the PDU Session Establishment procedure, the 5G network assigns a default QoS flow for the UE and may additionally assign indicated QoS flow(s) for the UE according to the UE request and/or according to instructions from the policy configured for the UE.

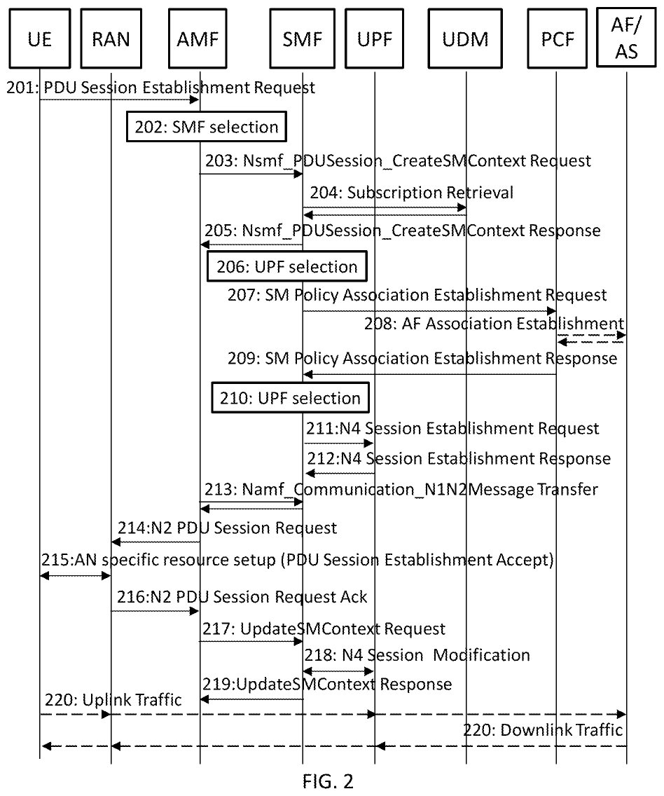

FIG. 2 shows a schematic diagram of a PDU Session Establishment procedure according to an embodiment of the present disclosure. In FIG. 2, the SMF assigns a set of QoS flows to guarantee communications between the UE and the Application Server (e.g., AF). Specifically, after the UE registers to 5G network, the UE may request the PDU session establishment procedure and the PDU session establishment procedure comprises:

Step 201: The UE transmits, to the AMF, NAS Message (e.g., Single Network Slice Selection Assistance Information (S-NSSAI(s)), UE Requested Data Network Name (DNN), PDU Session ID, Request type, N1 session management (SM) container (e.g., PDU Session Establishment Request)).

The PDU Session Establishment Request is included in the NAS message and encapsulated in the N1 SM container. The NAS message sent by the UE is encapsulated by the RAN in an N2 message towards the AMF.

Step 202: The AMF selects a proper SMF (i.e., anchor SMF) to serve the PDU session based on the requested DNN, the S-NSSAI and the current UE location information.

Step 203: The AMF transmits, to the SMF, Nsmf_PDUSession_CreateSMContext Request (comprising Subscription Permanent Identifier (SUPI), selected DNN, UE requested DNN, S-NSSAI(s), PDU Session ID, AMF ID, Request Type, N1 SM container (comprising PDU Session Establishment Request), User location information, Access Type, radio access technology (RAT) Type, Permanent Equipment Identifier (PEI), Generic Public Subscription Identifier (GPSI)).

The SUPI uniquely identifies the UE subscription. The AMF ID carries Globally Unique AMF ID (GUAMI) uniquely identifies the AMF serving the UE.

Step 204: To serve the PDU session, the SMF retrieves session management subscription data from the UDM, if it has no such information previously retrieved.

Step 205: The SMF transmits, to the AMF, Nsmf_PDUSession_CreateSMContext Response (comprising Cause, SM Context ID). The SM Context ID identifies the SM context created in the SMF for the UE.

Step 206: If dynamic policy and charging control (PCC) is configured to be used for the PDU Session, the SMF selects a proper PCF to serve the PDU session.

Step 207: The SMF sends an Npcf_PolicyAssociation_Create Request to the PCF, to perform an SM Policy Association Establishment procedure and to get the default PCC Rules for the PDU Session. Necessary parameters such as SUPI, PDU Session ID, DNN, S-NSSAI shall be provided in the request. Other parameters such as GPSI, UE IP address, UE External ID, RAT Type, Access Type, may also be provided in the request message.

Step 208: The PCF may interact with the AF to establish AF association. The AF association establishment allows the AF to dynamically influence the traffic model of the PDU session via the PCF, e.g., to establish new dedicated QoS flow or to modify the existing Qos flow.

Step 209: The PCF sends an Npcf_PolicyAssociation_Create Response to the SMF, to return the default PCC Rules for the PDU Session.

Step 210: The SMF selects an UPF acting as PDU Session Anchor (PSA).

Step 211: The SMF sends an N4 Session Establishment Request to the UPF to request establishing a N4 session for this PDU Session, carrying a set of rules for packet detection and QoS enhancement to be installed in the UPF. The rules include Packet Detection Rule (PDR), Forward Action Rule (FAR), QoS Enhancement Rule (QER), Usage Reporting Rule (URR), etc.

If the SMF receives the PCC rules from the PCF, the SMF maps the PCC rules to a set of QoS flows and generates a set of PDR/FAR/QER/URR rules accordingly to reflect the determined QoS flows.

The UPF installs these rules for this PDU session and uses these rules to filter the uplink/downlink traffic and performs corresponding QoS enhancement to the filtered uplink/downlink traffic.

Step 212: The UPF acknowledges by sending an N4 Session Establishment Response to the SMF.

Step 213: The SMF transmits, to the AMF, an Namf_Communication_N1N2MessageTransfer Request (comprising PDU Session ID, N2 SM information (PDU Session ID, QFI(s), QoS Profile(s), N3 CN Tunnel Info), N1 SM container (PDU Session Establishment Accept)).

The N2 SM information carries information which shall be forwarded by the AMF to the RAN. For example, the N2 SM information may comprise the N3 CN Tunnel Info carrying I-UPF UL F-TEID, the QFIs and QoS profiles used by the RAN to set up QoS flows. One or multiple QoS profiles and the corresponding QFIs are provided to the RAN, to allow the RAN to control the QoS flow and perform traffic detection and admission control at QoS flow level.

In an embodiment, the QoS profile comprises the following parameters:
QFI, used to uniquely identify one QoS flow in a PDU session;
ARP, indicates the Allocation and Retention Priority of the QoS flow;
GBR QOS flow parameters, used by the RAN to control the QoS flow, such as Maximum Flow Bit Rate Downlink, Maximum Flow Bit Rate Uplink, Guaranteed Flow Bit Rate Downlink, Guaranteed Flow Bit Rate Uplink, Maximum Packet Loss Rate Downlink, Maximum Packet Loss Rate Uplink, etc.;

The N1 SM container comprises the PDU Session Establishment Accept that the AMF shall provide to the UE. Within the PDU Session Establishment Accept, the following parameters are included: PDU session ID, PDU session type, UE IP address, one or multiple QoS rules, QoS Flow level QoS parameters associated to those QoS rule(s), DNN, S-NSSAI, etc.

Step 214: The AMF transmits, to the RAN, an N2 PDU Session Request (comprising N2 SM information, NAS message (PDU Session ID, N1 SM container (PDU Session Establishment Accept))). The AMF sends the NAS message containing PDU Session ID and PDU Session Establishment Accept targeted to the UE and the N2 SM information received from the SMF within the N2 PDU Session Request to the RAN.

Step 215: The RAN may issue AN specific signaling exchange with the UE that is related with the information received from SMF. For example, in case of a 3GPP RAN, an RRC Connection Reconfiguration may take place with the UE establishing the necessary RAN resources related to the QoS Rules for the PDU Session request. RAN forwards the NAS message (PDU Session ID, N1 SM container (PDU Session Establishment Accept)) to the UE. RAN also allocates AN N3 tunnel information for the PDU Session.

Step 216: The RAN transmits, to the AMF, an N2 PDU Session Response (comprising PDU Session ID, Cause, N2 SM information (PDU Session ID, AN Tunnel Info, List of accepted/rejected QFI(s))).

In an embodiment, the AN Tunnel Info corresponds to the Access Network address of the N3 tunnel corresponding to the PDU Session.

Step 217: The AMF transmits, to the SMF, an Nsmf_PDUSession_UpdateSMContext Request (N2 SM information). The AMF forwards the N2 SM information received from RAN to the SMF. If the list of rejected QFI(s) is included in the N2 SM information, the SMF releases the rejected QFI(s) associated QoS profiles.

Step 218: The SMF initiates an N4 Session Modification procedure with the UPF. The SMF provides RAN Tunnel Info to the UPF as well as the corresponding forwarding rules.

Step 219: The SMF sends an Nsmf_PDUSession_UpdateSMContext Response to the AMF.

Step 220: The UE initiates uplink traffic transmission(s) (e.g., towards its Application Server) or receives downlink traffic (e.g., from its Application Server). During the PDU Session Establishment procedure, the SMF allocates the default QoS flow to the UE for the PDU session. The SMF may also allocate dedicated QoS flows for the PDU session, if the SMF is instructed by the locally configured PCC rules (e.g., associated to the DNN, S-NSSAI), or instructed by the dynamic PCC rules from the PCF.

On the demand of application traffic transmission, a PDU Session Modification procedure may be initiated by the UE or the PCF, to request the SMF to allocate dedicated QoS flows for the PDU session. The SMF retrieves updated PCC rules from the PCF and allocates the dedicated QoS flows accordingly. After allocating the dedicated QoS flows, the SMF sends the N2 SM information to the RAN, to update the QFIs and the QoS profiles stored in the RAN. The SMF also sends the N1 SM Container to the UE, to update the QoS flows and the QoS rules stored in the UE.

Once the PDU session is established, the UE sends and/or receives data traffic (e.g., IP packets) over the IP address assigned by the network to this PDU session. The uplink data traffic sent by the UE is encapsulated, by the RAN, into GTP-U packets forwarded to the UPF and the downlink data traffic sent to the UE is encapsulated, by the UPF, into GTP-U packets forwarded to the RAN.

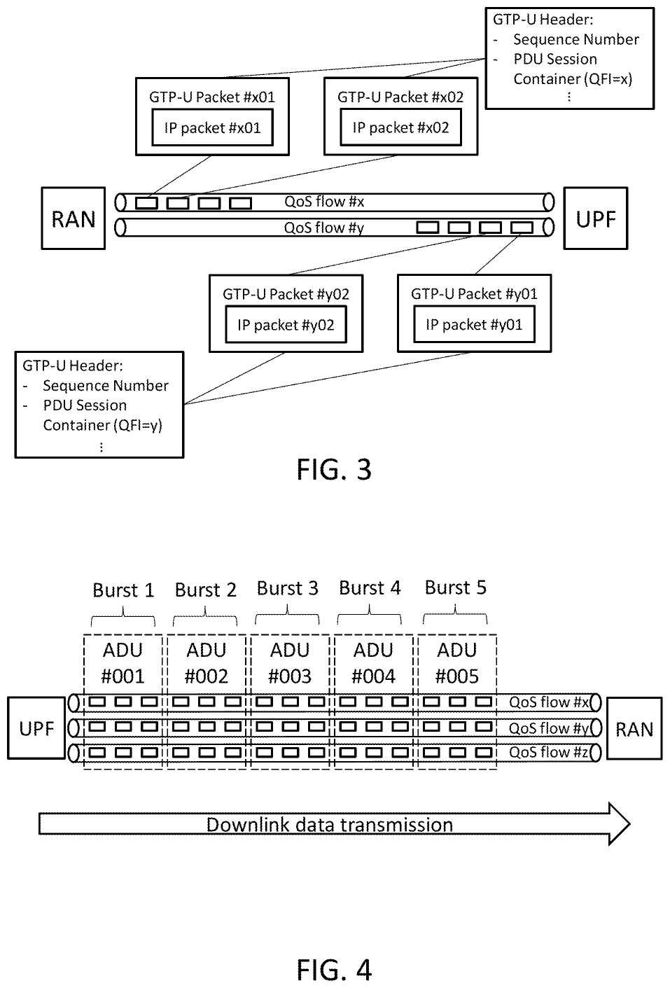

In the 5G network, in order to allow the peer GTP-U entities (e.g., RAN and UPF) to recognize which QoS flow to which the GTP-U packets belong, a PDU Session Container information element (IE) is attached to GTP-U headers of the GTP-U packets. The PDU Session Container IE further carries a QFI IE clearly identifying the QoS flow to which the inner packets belong, as illustrated in FIG. 3.

FIG. 3 shows a schematic diagram of 5G data traffic according to an embodiment of the present disclosure. In FIG. 3, the 5G data traffic encapsulation and transmission model support the QoS flow model. The data traffic is encapsulated in GTP-U packets and each GTP-U packet is identified by the QFI carried in the GTP-U extension header—PDU Session Container IE. The data traffic encapsulation and transmission model shown in FIG. 3 may have difficulty in supporting new service requirements raised by the XR or XR-like services.

In order to support data transmissions of the XR and/or the XR-like service, the present disclosure introduces a new data traffic correlation model which groups different types of data traffic (e.g., audio/video/haptic/sensor traffic) jointly processed by the application in one certain period into single Application Data Unit (ADU). That is the data traffic belonging to different QoS flows in one certain period may be grouped into one ADU.

In an embodiment, to support the ADU transmission, the data transmission node (e.g., GTP-U entity such as RAN and UPF) may logically group data traffic belonging to different QoS flows to one single ADU and handle the data traffic within the same ADU according to the same traffic correlation policy.

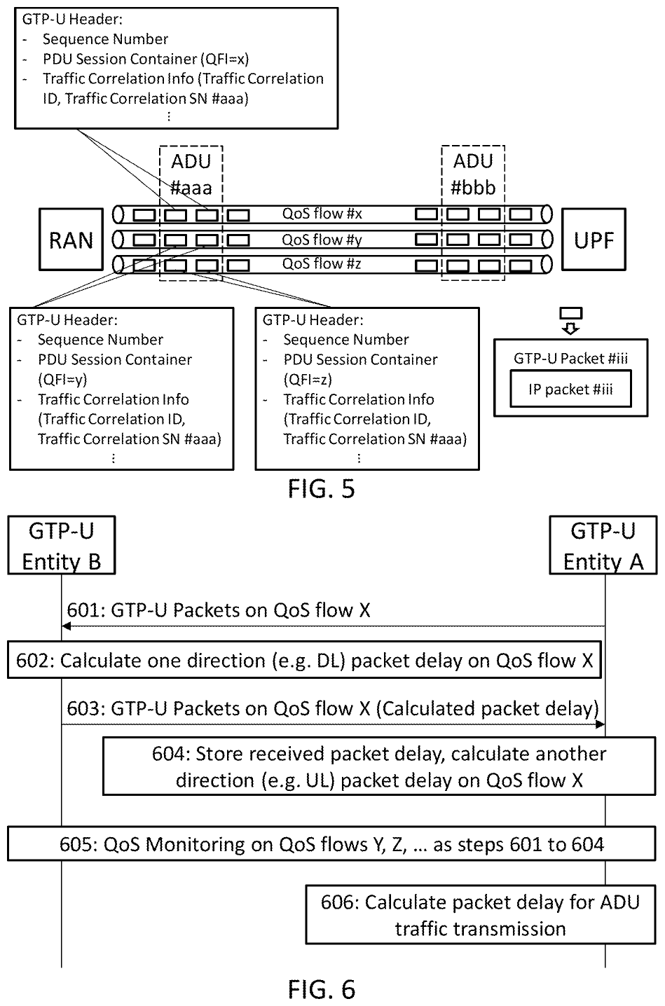

FIG. 4 shows a schematic diagram of 5G data traffic according to an embodiment of the present disclosure. In FIG. 4, sequential transmissions of ADUs between two GTP-U entities, e.g., from the UPF to the RAN, are described. As shown in the FIG. 4, a sending GTP-U entity (i.e., UPF) recognizes that data traffic transmitted in one certain period on different QoS flows (i.e., QoS flows #x, #y, #z) separately belongs to the ADUs. Once detecting of an ADU transmission, the sending GTP-U entity attaches information associated with (marking) the ADU transmission in the GTP-U packet when encapsulating the data traffic to the GTP-U packets, as shown in an embodiment in FIG. 5. Specifically, when performing the GTP-U packet encapsulation for the ADU transmission, the sending GTP-U entity (e.g., RAN/UPF) may carry Traffic Correlation Info (TCI) in the GTP-U extension header.

In an embodiment, the Traffic Correlation Info comprises a Traffic Correlation ID (TCID). The TCID may be used to uniquely identify a type of the corresponding ADU.

In an embodiment, the TCID may further comprise/indicate at least one of:
a Correlation Policy ID, configured to identify the correlation policy applied to multiple QoS flows;
an Application Data Unit Type (ADU Type), configured to identify the type of the ADU being transmitted;
an Application Type, configured to identify the type of Application to which the data packets belong;
an Application ID, configured to identify the Application to which the data packets belong;

In an embodiment, the Traffic Correlation Info may further comprise at least one of:
ADU Sequence Number (ADU SN): The ADU SN is used to differentiate sequential ADUs from each other under the same Traffic Correlation ID. For example, two ADUs shown in FIG. 5 have the same Traffic Correlation ID and respectively comprise ADU SNs #aaa and #bbb. The UPF/RAN is able to differentiate the ADUs shown in FIG. 5 based on their own ADU SN.
ADU Size: The ADU size is used to indicate the total size of one ADU package;

In an embodiment, some packets of an ADU are more important than other packets inside the ADU. In this embodiment, the Traffic Correlation Info may further comprise:
Importance Level of ADU Inner Packet: The Importance Level of ADU Inner Packets is used to indicate an importance level of the packet inside the ADU. For example, precentor data packet(s) (e.g., announcement data block(s)) of one ADU normally carries important information of the whole ADU. Thus, the precentor data packets are marked with higher importance level. That is, the Importance of ADU Inner Packets in the header of each precentor data packet indicates an importance level higher than that of the remaining packets in the same ADU.

In an embodiment of redundant transmission feature being supported, the ADU traffic may be duplicated and sent via two separate transmission paths. Under such conditions, the Traffic Correlation Info may further comprise:
ADU Duplication Number, which is used to identify the duplication of ADU traffic. For example, if one ADU is duplicated and transmitted via two separate transmission paths, the Traffic Correlation Info (e.g., in the GTP-U header) of the ADU carries the corresponding ADU Duplication Number.

When receiving the GTP-U packets in the ADU, the receiving GTP-U entity recognizes the Traffic Correlation Info from the GTP-U header, and may apply one of the following correlation actions to the ADU traffic transmission:
a) Traffic detection for ADU traffic:

If the traffic detection for (subsequent) ADU traffic is required, the GTP-U entity (e.g., RAN/UPF) monitors the GTP-U header to check the Traffic Correlation Info, to detect whether the GTP-U packet is belonging to an ADU. Upon the detection of the ADU, the GTP-U entity may, e.g., apply the QoS policy enforcement for the detected ADU, if required as per the following item b). The GTP-U entity may also apply QoS monitoring for all detected ADU traffic, if required, as per the following item c) and/or report the QoS monitoring events, if required, as per the following item d).
b) QoS policy enforcement for ADU traffic:

If the QoS policy enforcement for ADU traffic is required, the GTP-U entity (e.g., RAN/UPF) applies the corresponding Traffic Correlation Policy to all QOS flows affected by the Traffic Correlation Policy. For example, the same Traffic Correlation Policy may be applied on the data traffic of different QoS flows corresponding to the same Traffic Correlation ID.
c) QoS monitoring for ADU traffic:

The GTP-U entity may perform measurement on (e.g., monitor) at least one of the following key performance indicators (KPIs):
ADU Packet Delay: The ADU Packet Delay may include at least one of: Average ADU DL/UL Packet Delay, Maximum ADU DL/UL Packet Delay, Deviation of ADU DL/UL Packet Delay;
ADU Packet Loss Rate: The ADU Packet Loss Rate may include at least one of: Average ADU DL/UL Packet Loss Rate, Maximum ADU DL/UL Packet Loss Rate, Deviation of ADU DL/UL Packet Loss Rate;
ADU Un-synchronization Rate: The ADU Un-synchronization Rate may be measured based on the rate of un-synchronization in transmission of data traffic (belonging to the same ADU) of different QoS flows.

In an embodiment, the Maximum ADU DL/UL Packet Loss Rate represents the maximum DL/UL Packet Loss Rate among the QoS flows in the ADU.
d) QoS monitoring event report for ADU traffic:

The GTP-U entity (e.g., RAN/UPF) may be required to report the detected QoS monitoring event (e.g., report the detected average Packet Delay of QoS follows, report the average Packet Loss Rate of QoS flows, etc.). That is the GTP-U entity (e.g., RAN/UPF) may report the detected QoS monitoring event to the NF which collects the QoS monitoring event report for the ADU traffic.

FIG. 6 shows a schematic diagram of a procedure according to an embodiment of the present disclosure. In FIG. 6, the GTP-U entity A (e.g., RAN/UPF) sends the GTP-U packets supporting the ADU transmission and calculates/monitors related KPIs (e.g., packet delay) for the ADU transmissions.

Step 601: The GTP-U Entity A (e.g., UPF) sends GTP-U packets (e.g., DL GTP-U packets) to the GTP-U Entity B (e.g., RAN).

In this embodiment, the GTP-U Header of each GTP-U packet carries the following information:
QFI: The QFI is used to identify the QoS flow. For example, the QFI indicates a value X.
Traffic Correlation Info: In this embodiment, the Traffic Correlation Info comprises a Traffic Correlation ID. In an embodiment, the Traffic Correlation Info further comprises an ADU Sequence Number.
Sending Timestamp: The Sending timestamp may be used to identify the time of the sending GTP-U entity A sending the GTP-U packets to the receiving GTP-U entity B on the QoS flow identified by the indicated QFI. For example, the Sending Timestamp may equal a value @val#1.

Step 602: The GTP-U Entity B receives the GTP-U packets from the GTP-U Entity A. Based on the sending timestamp, the GTP-U Entity B calculates the Packet Delay Result on this QoS flow (e.g. QFI=X) and on the direction from the GTP-U Entity A to the GTP-U Entity B (e.g. DL direction when the GTP-U Entity A is the UPF and the GTP-U Entity B is the RAN).

For example, a Received Timestamp of the received GTP-U packet is recorded by the GTP-U Entity B. The Received Timestamp is used to identify the time when the GTP-U Entity B receiving the GTP-U packets with the indicated Sending Timestamp on the indicated QoS flow (e.g., QFI=X). For instance, the Received Timestamp equals value @val#2.

The Packet Delay Result on the direction from the GTP-U entity A to the GTP-U entity B may be calculated by:

Packet Delay Result =Received Timestamp-Sending Timestamp.

For example, the Packet Delay Result (on direction A to B) equals @val#4=@val#2−@val#1.

Step 603: The GTP-U Entity B sends GTP-U packets to the GTP-U Entity A.

In this embodiment, the GTP-U Header of each GTP-U packet comprises the following information:
QFI: The QFI is used to identify the QoS flow. For example, the QFI indicates a value X.
Traffic Correlation Info: The Traffic Correlation Info comprises the Traffic Correlation ID and optionally the ADU Sequence Number.
Sending Timestamp Repeated: Sending Timestamp Repeated is used to identify the timestamp indicated in the GTP-U packets sent by the GTP-U Entity A. For example, the Sending Timestamp Repeated equals value @val#1.
Received Timestamp, identifying the timestamp when the GTP-U Entity B receives the GTP-U packets with the indicated Sending Timestamp on the indicated QoS flow. For example, the Received Timestamp equals value @val#2.
Sending Timestamp, identifying the timestamp when the GTP-U Entity B sends GTP-U packets to the GTP-U Entity A. For example, the Sending Timestamp equals value @val#3.
Packet Delay Result (on direction A to B), identifying the packet delay detected by the GTP-U Entity on this direction (e.g., DL direction-from the UPF to the RAN). For example, the Packet Delay Result equals value @val#4.

Step 604: The GTP-U Entity A stores the received Packet Delay Result (on direction from A to B) and calculates the Packet Delay Result on the other direction (on direction from GTP-U Entity B to the GTP-U Entity A).

For example, the RAN calculates the Packet Delay Result on the direction from the UPF to the RAN, i.e., DL Packet Delay Result. The UPF calculates the Packet Delay Result on the UL direction from the RAN to the UPF, i.e., UL Packet Delay Result.

Step 605: On other QoS flows, the UL/DL Packet Delay Results are detected by the GTP-U Entity A (e.g., UPF) and/or the GTP-U Entity B (e.g., RAN) similarly as steps 601 to 604.

Step 606: Once the Packet Delay for each QoS flow associated to the ADU is detected/measured, the GTP-U Entity A/B (e.g., RAN/UPF) can calculate the packet delay for the ADU transmissions (i.e., ADU packet delay).

For example, the GTP-U entity (e.g., RAN/UPF) can use the UL/DL Packet Delay Result on each QoS flow associated to the ADU to calculate one of the following KPIs:
Average ADU UL Packet Delay, or Average ADU DL Packet Delay;
Maximum ADU UL Packet Delay, or Maximum ADU DL Packet Delay;
Deviation of ADU UL Packet Delay, or Deviation of ADU DL Packet Delay.

In an embodiment, the GTP-U entity can use the similar procedure as described in FIG. 6 to calculate (statics of) other KPIs of the ADU transmissions, e.g., ADU Packet Loss Rate, ADU Un-synchronization Rate, etc.

It should be noted that, the aforementioned embodiments use the GTP-U protocol, i.e., protocol used between two data transmission nodes (e.g., UPF/RAN), for illustration purposes only. Other data transmission protocols (e.g., Segment Routing IPV6 (SRV6)) may be introduced for user data transmissions. That is the data transmission node (e.g., UPF/RAN) may include the Traffic Correlation Info into the packet header of the adopted data transmission protocol.

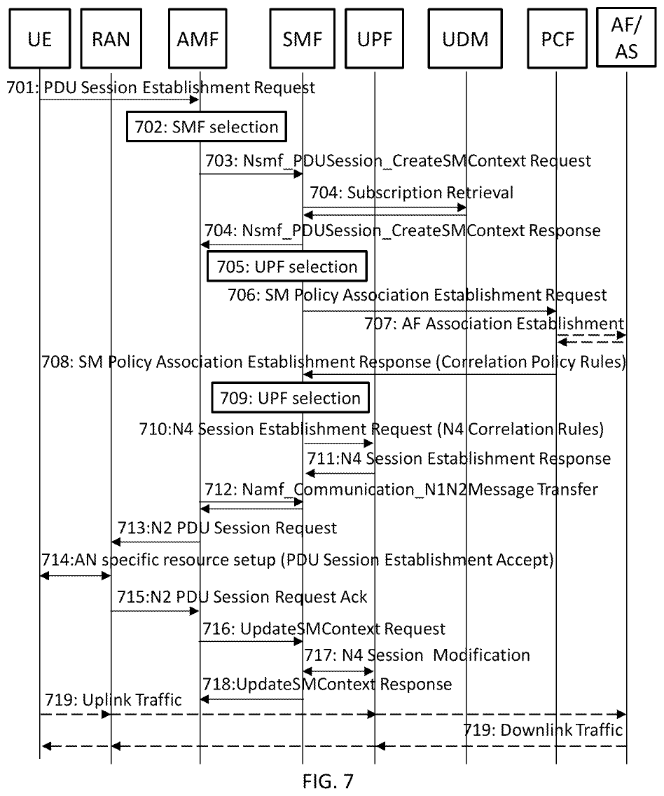

The Embodiments shown in FIGS. 4 to 6 describe how the GTP-U entity (e.g., RAN/UPF) applies correlation actions on the data traffic of the correlated QoS flows, e.g., applying correlation actions to ADU traffic transmission. The following FIG. 7 shows a schematic diagram of a PDU Session Establishment procedure according to an embodiment of the present disclosure. In FIG. 7, the RAN/UPF is provided with instructions on how to apply correlation actions to the correlated QoS flows.

Step 701: The UE transmits, to the AMF, NAS Message (comprising S-NSSAI(s), UE Requested DNN, PDU Session ID, Request type, N1 SM container (e.g., comprising PDU Session Establishment Request)).

The PDU Session Establishment Request is included in the NAS message and encapsulated in the N1 SM container. The NAS message sent by the UE is encapsulated by the RAN in an N2 message towards the AMF.

Step 702: The AMF selects a proper SMF (i.e., anchor SMF) to serve the PDU session based on the requested DNN, the S-NSSAI and the current UE location information.

Step 703: The AMF transmits, to the SMF, Nsmf_PDUSession_CreateSMContext Request (comprising SUPI, selected DNN, UE requested DNN, S-NSSAI(s), PDU Session ID, AMF ID, Request Type, N1 SM container (comprising PDU Session Establishment Request), User location information, Access Type, RAT Type, PEI, GPSI).

The SUPI uniquely identifies the UE subscription. The AMF ID carries GUAMI uniquely identifies the AMF serving the UE.

Step 704: To serve the PDU session, the SMF retrieves session management subscription data from the UDM, if the SMF has not retrieved such information.

Step 705: The SMF transmits, to the AMF, Nsmf_PDUSession_CreateSMContext Response (comprising Cause, SM Context ID). The SM Context ID identifies the SM context created in the SMF for the UE.

Step 706: If dynamic PCC is configured to be used for the PDU Session, the SMF selects a proper PCF to serve the PDU session.

Step 707: The SMF sends an Npcf_PolicyAssociation_Create Request to the PCF, to perform an SM Policy Association Establishment procedure and to get the default PCC Rules for the PDU Session. Necessary parameters such as SUPI, PDU Session ID, DNN, S-NSSAI shall be provided in the request. Other parameters such as GPSI, UE IP address, UE External ID, RAT Type, Access Type, may also be provided in the request message.

Step 708: When answering the AF association Establishment request, the AF may return the Traffic Transmission Characteristics to the PCF, to indicate the traffic transmission pattern/characteristics of this service.

For example, the Traffic Transmission Characteristics may comprise at least one of:
a list of QoS flows,
at least one precentor QoS flow ID associated with at least one precentor QoS flow on which the First Data Block (e.g., announcement data block) in the APU transmission is transmitted,
Transmission Pattern of First Data Block in an ADU, identifying the transmission pattern of the First Data Block of one ADU. The remaining data blocks are transmitted after the First Data Block,
Maximum Size of one ADU, indicating the maximum size in one burst of ADU,
Maximum Duration of one ADU, indicating the maximum transmission duration in one burst of ADU,
Fixed Transmission Pattern of ADUs, indicating the fixed transmission pattern of ADU. It may comprise at least one of: Fixed Duration of one ADU transmission, Fixed Size of one ADU transmission, Sleep Duration between two subsequent ADUs.

Step 709: The PCF sends Npcf_PolicyAssociation_Create Response to the SMF, to return/indicate/instruct default PCC Rules (e.g., Correlation Policy Rules) for the PDU Session.

In step 709, the PCF may include Traffic Correlation Policy and/or Correlated Traffic Characteristics in the response message.

The Traffic Correlation Policy provides instructions to the interested NF (e.g., SMF/UPF/RAN), to correlate different QoS flows and apply the correlation policy and actions to those correlated QoS flows.

In an embodiment, the Traffic Correlation Policy may comprise at least one of:
Correlation Policy ID, identifying the Traffic Correlation Policy;
A list of correlated QoS flows, each identified by its QFI;
A list of QoS monitoring actions for correlated QoS flows, such as: monitoring the Packet Delay for correlated QoS flows, monitor the Packet Loss Rate for correlated QoS flows, etc.;
A list of event report thresholds for correlated QoS flows, such as: threshold for Average Packet Delay for correlated QoS flows, threshold for Average Packet Loss Rate for correlated QoS flows, threshold for Deviation of Packet Delay for correlated QoS flows, threshold for Deviation of Packet Loss Rate for correlated QoS flows, etc.
A list of event report triggers for correlated QoS flows, such as: report the Average Packet Delay for correlated QoS flows, report the Average Packet Loss Rate for correlated QoS flows, report the Deviation of Packet Delay for correlated QoS flows, report the Deviation of Packet Loss Rate for correlated QoS flows;

In an embodiment, the Correlated Traffic Characteristics provides instructions to interested NF (e.g., the SMF/RAN/UPF), to detect the transmission start and stop of one Correlate Data Unit. Based on the Correlated Traffic Characteristics, the SMF therefore can mark the Traffic Correlation Info to the GTP-U headers and identify the characteristics of data traffic transmission of those correlated QoS flows.

In an embodiment, the Traffic Correlation Characteristics may comprise at least one of:
a list of QoS flows,
at least one precentor QoS flow ID associated with at least one precentor QoS flow on which the First Data Block (e.g., announcement data block) in the APU transmission is transmitted,
Transmission Pattern of First Data Block in an ADU, identifying the transmission pattern of the First Data Block of one ADU. The remaining data blocks are transmitted after the First Data Block,
Maximum Size of one ADU, indicating the maximum size in one burst of ADU,
Maximum Duration of one ADU, indicating the maximum transmission duration in one burst of ADU,
Fixed Transmission Pattern of ADUs, indicating the fixed transmission pattern of ADU. It may comprise at least one of: Fixed Duration of one ADU transmission, Fixed Size of one ADU transmission, Sleep Duration between two subsequent ADUs.

If the Traffic Correlation Characteristics is provided, it shall be associated to a list of correlated QoS flows. The list of correlated QoS flows may be included in the Traffic Correlation Characteristics or be included within an associated Traffic Correlation Policy.

Step 710: The SMF selects an UPF acting as PDU Session Anchor (PSA).

Step 711: The SMF sends an N4 Session Establishment Request to the UPF, to request establish an N4 session for this PDU Session, wherein the N4 Session Establishment Request carries a set of PDR/FAR/QER/URR rules (e.g., N4 Correlation Rules).

If the Traffic Correlation Policy is received by the SMF in the previous step, the SMF may also include the received Traffic Correlation Policy in the request message. As an alternative or in addition, the SMF includes the mapped N4 Correlation Rules mapped from the Traffic Correlation Policy in the request message.

If the Correlated Traffic Characteristics are received by the SMF in the previous step, the SMF may also provide the Correlated Traffic Characteristics to the UPF. The Correlated Traffic Characteristics provide instructions to the UPF on how to detect the burst of the ADUs, and thus can apply corresponding actions on the ADUs.

Step 712: The UPF acknowledges by sending an N4 Session Establishment Response.

If the Traffic Correlation Policy (or the N4 Correlation Rules) is received by the UPF, the UPF install such rules, together with the PDR/FAR/QER/URR rules. The Traffic Correlation Policy (or the N4 Correlation Rules) gives instruction to the UPF on how to correlate different QoS flows, apply correlation policy to those correlated QoS flows, and perform QoS monitoring for those correlated QoS flows.

If the Correlated Traffic Characteristics is received by the UPF, the UPF stores such information, and later uses this information to detect and handle the transmission of ADU.

Step 713: The SMF transmits, to the AMF, an Namf_Communication_N1N2MessageTransfer Request. In an embodiment, the Namf_Communication_N1N2MessageTransfer Request comprises PDU Session ID, N2 SM information (e.g., PDU Session ID, QFI(s), QoS Profile(s), N3 CN Tunnel Info, Correlation Policy Rules), and N1 SM container (PDU Session Establishment Accept).

If the Traffic Correlation Policy is received by the SMF in the previous step, the SMF may also include such information in the N2 SM information. The Traffic Correlation Policy provides instruction to the RAN on how to correlate different QoS flows, apply correlation policy to those correlated QoS flows, and perform QoS monitoring for those correlated QoS flows.

If the Correlated Traffic Characteristics is received by the SMF in the previous step, the SMF may also include such information in the N2 SM information. The Correlated Traffic Characteristics provides instruction to the RAN on how to detect the burst of ADU, and thus can apply corresponding actions to it.

Step 714: The AMF transmits, to the RAN, an N2 PDU Session Request (comprising N2 SM information, NAS message (PDU Session ID, N1 SM container (PDU Session Establishment Accept))). The AMF sends the NAS message containing PDU Session ID and PDU Session Establishment Accept targeted to the UE and the N2 SM information received from the SMF within the N2 PDU Session Request to the RAN.

Step 715: The RAN may issue AN specific signaling exchange with the UE that is related with the information received from the SMF. For example, in case of a 3GPP RAN, an RRC Connection Reconfiguration may take place with the UE establishing the necessary RAN resources related to the QoS Rules for the PDU Session request. RAN forwards the NAS message (PDU Session ID, N1 SM container (PDU Session Establishment Accept)) to the UE. RAN also allocates AN N3 tunnel information for the PDU Session.

Step 716: The RAN transmits, to the AMF, an N2 PDU Session Response (comprising PDU Session ID, Cause, N2 SM information (PDU Session ID, AN Tunnel Info, List of accepted/rejected QFI(s))).

In an embodiment, the AN Tunnel Info corresponds to the Access Network address of the N3 tunnel corresponding to the PDU Session.

Step 717: The AMF transmits, to the SMF, an Nsmf_PDUSession_UpdateSMContext Request (N2 SM information). The AMF forwards the N2 SM information received from RAN to the SMF. If the list of rejected QFI(s) is included in the N2 SM information, the SMF releases the rejected QFI(s) associated QoS profiles.

Step 718: The SMF initiates an N4 Session Modification procedure with the UPF. The SMF provides RAN Tunnel Info to the UPF as well as the corresponding forwarding rules.

Step 719: The SMF sends an Nsmf_PDUSession_UpdateSMContext Response to the AMF.

Step 720: The UE initiates uplink traffic transmission (e.g., towards its Application Server) or receives downlink traffic (e.g., from its Application Server).

In the procedure described in FIG. 7, the SMF/UPF/RAN acquires the instructions of how to correlate different QoS flows and/or how to detect a start/end of transmission of an ADU and apply the correlation policy to the ADU.

For the UPF, once it gets the Traffic Correlation Characteristics, and/or N4 Correlation Rules, it can perform at least one of:
a) Detecting the transmission start/end of a burst of ADUs:

To detect the transmission start/end of a burst ADU, the UPF may perform the following actions to the data transmission:
Identify the QoS flow to which the data traffic belongs;
Identify whether the identified QoS flow is in the list of correlated QoS flows;
Identify whether the data transmission matches the characteristics described in the Traffic Correlation Characteristics.
b) Attaching the Traffic Correlation Info to the GTP-U header for those GTP-U packets encapsulates the data traffic belonging to one ADU, e.g., as described in FIGS. 4 to 6;
c) Applying Traffic Correlation Policy to the ADU transmission, e.g., as described in FIGS. 4 to 6;
d) Performing QoS monitoring and event report for the ADU transmission, e.g., as described in FIGS. 4 to 6.

For the RAN, once the RAN gets the Traffic Correlation Characteristics and/or Traffic Correlation Policy, the RAN can perform similar actions as the UPF does.

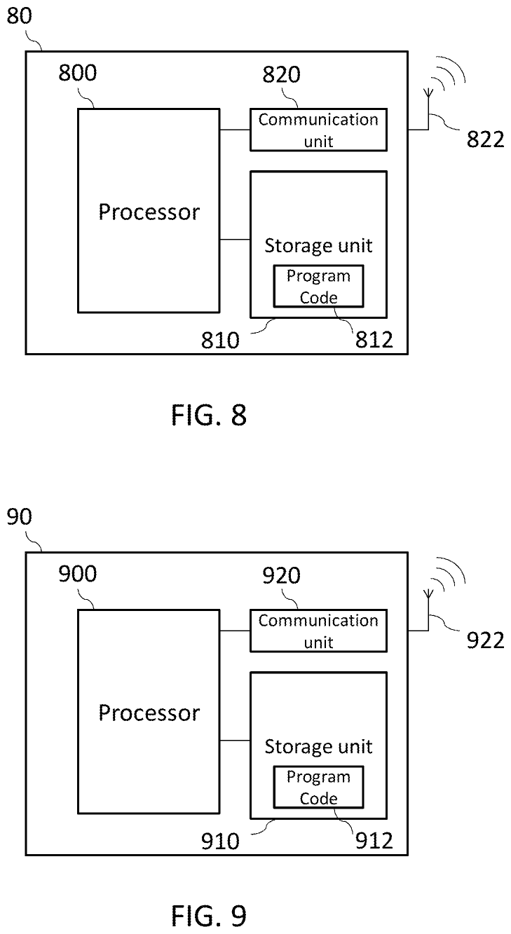

FIG. 8 relates to a schematic diagram of a wireless terminal 80 according to an embodiment of the present disclosure. The wireless terminal 80 may be a user equipment (UE), a mobile phone, a laptop, a tablet computer, an electronic book or a portable computer system and is not limited herein. The wireless terminal 80 may include a processor 800 such as a microprocessor or Application Specific Integrated Circuit (ASIC), a storage unit 810 and a communication unit 820. The storage unit 810 may be any data storage device that stores a program code 812, which is accessed and executed by the processor 800. Embodiments of the storage unit 812 include but are not limited to a subscriber identity module (SIM), read-only memory (ROM), flash memory, random-access memory (RAM), hard-disk, and optical data storage device. The communication unit 820 may a transceiver and is used to transmit and receive signals (e.g., messages or packets) according to processing results of the processor 800. In an embodiment, the communication unit 820 transmits and receives the signals via at least one antenna 822 shown in FIG. 8.

In an embodiment, the storage unit 810 and the program code 812 may be omitted and the processor 800 may include a storage unit with stored program code.

The processor 800 may implement any one of the steps in exemplified embodiments on the wireless terminal 80, e.g., by executing the program code 812.

The communication unit 820 may be a transceiver. The communication unit 820 may as an alternative or in addition be combining a transmitting unit and a receiving unit configured to transmit and to receive, respectively, signals to and from a wireless network node (e.g., a base station).

FIG. 9 relates to a schematic diagram of a wireless network node 90 according to an embodiment of the present disclosure. The wireless network node 90 may be a satellite, a base station (BS), a network entity, a Mobility Management Entity (MME), Serving Gateway (S-GW), Packet Data Network (PDN) Gateway (P-GW), a radio access network (RAN) node, a next generation RAN (NG-RAN) node, a gNB, an eNB, a gNB central unit (gNB-CU), a gNB distributed unit (gNB-DU) a data network, a core network or a Radio Network Controller (RNC), and is not limited herein. In addition, the wireless network node 90 may comprise (perform) at least one network function such as an access and mobility management function (AMF), a session management function (SMF), a user place function (UPF), a policy control function (PCF), an application function (AF), etc. The wireless network node 90 may include a processor 900 such as a microprocessor or ASIC, a storage unit 910 and a communication unit 920. The storage unit 910 may be any data storage device that stores a program code 912, which is accessed and executed by the processor 900. Examples of the storage unit 912 include but are not limited to a SIM, ROM, flash memory, RAM, hard-disk, and optical data storage device. The communication unit 920 may be a transceiver and is used to transmit and receive signals (e.g., messages or packets) according to processing results of the processor 900. In an example, the communication unit 920 transmits and receives the signals via at least one antenna 922 shown in FIG. 9.

In an embodiment, the storage unit 910 and the program code 912 may be omitted. The processor 900 may include a storage unit with stored program code.

The processor 900 may implement any steps described in exemplified embodiments on the wireless network node 90, e.g., via executing the program code 912.

The communication unit 920 may be a transceiver. The communication unit 920 may as an alternative or in addition be combining a transmitting unit and a receiving unit configured to transmit and to receive, respectively, signals to and from a wireless terminal (e.g., a user equipment or another wireless network node).

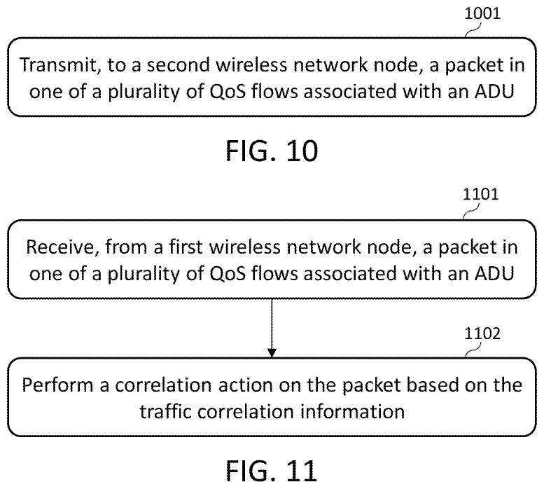

FIG. 10 shows a flowchart of a method according to an embodiment of the present disclosure. The method shown in FIG. 10 may be used in a first wireless network node (e.g., UPF, RAN, a wireless network node comprising the UPF or RAN, a wireless network node performing at least part of functionalities of UPF or RAN) and comprises:

Step 1001: Transmit, to a second wireless network node, a packet in one of a plurality of QoS flows associated with an ADU.

The concept of ADU is introduced in this embodiment. The packets belong to one ADU may be transmitted on different QoS flows. For example, the packets of the ADU may comprise data required to be highly synchronized (e.g., video, sound, sensor data for XR or XR-like services). Before transmitting the packets of the ADU, the first wireless network node attaches/adds/encapsulates traffic correlation information of the ADU in the header of each packet. The traffic correlation information may be used to correlate/associate the packets on different QoS flows together (e.g., as single ADU). That is, based on the traffic correlation information, the second wireless network node receiving the packet is able to identify/recognize the ADU to which the packet belongs and perform subsequent actions on the packet.

In an embodiment, the traffic correlation information comprises a traffic correlation ID of the ADU. For instance, the traffic correlation ID may comprises/indicate at least one of:
a correlation policy ID associated with a correlation policy applied on the plurality of QoS flows,
an application data unit type associated with a type of the ADU,
an application type associated with a type of an application to which the packet belongs, or
an application ID associated with the application to which the packet belongs.

In an embodiment, the traffic correlation information further comprises information associated with at least one of:
a sequence number of the ADU,
a size of the ADU,
an importance level of the packet in the ADU, or
a duplication number of the ADU.

In an embodiment, the packet is a GTP-U packet and the packet header is a GTP-U header. Note that other protocols may be used for data transmissions between the first wireless network node and the second wireless network node.

FIG. 11 shows a flowchart of a method according to an embodiment of the present disclosure. The method shown in FIG. 11 may be used in a second wireless network node (e.g., UPF, RAN, a wireless network node comprising the UPF or RAN, a wireless network node performing at least part of functionalities of UPF or RAN) and comprises:

Step 1101: Receive, from a first wireless network node, a packet in one of a plurality of QoS flows associated with an ADU.

Step 1102: Perform a correlation action on the packet based on the traffic correlation information.

In FIG. 11, the second wireless network node receives a packet in one of a plurality of QoS flows associated with an ADU from a first wireless network node, wherein a packet header of the packet comprises traffic correlation information associated with the ADU. The traffic correlation information may be used to correlate/associate the packets on different QoS flows together (e.g., as single ADU). Based on the traffic correlation information, the second wireless network node perform subsequent correlation actions on the packet. The detail of the traffic correlation information may be referred to the above embodiments.

In an embodiment, the packet is a GTP-U packet and the packet header is a GTP-U header. Note that other protocols may be used for data transmissions between the first wireless network node and the second wireless network node.

In an embodiment, the correlation actions performed by the second wireless network node comprises associating the packet with the ADU based on the traffic correlation information. That is the second wireless network node identifies/recognizes the ADU to which the packet belongs. After identifying the ADU, the second wireless network node may apply a correlation policy associated with the ADU on the packet and/or acquire at least one measurement result of the ADU and/or report QoS event(s) associated with the ADU.

In an embodiment, the correlation actions performed by the second wireless network node comprises applying a correlation policy associated with the ADU based on the traffic correlation information. According to the traffic correlation information, the second wireless network node acknowledges the correlation policy associated with the ADU and applies the correlation policy on the packets in the ADU.

In an embodiment, the correlation actions performed by the second wireless network node comprises acquiring at least one measurement result of the ADU (based on the traffic correlation information). For example, the measurement result(s) comprises at least one of:
an average packet delay of the plurality of QoS flows,
a deviation of packet delay of the plurality of QoS flows,
an average packet loss rate of the plurality of QoS flows,
a deviation of packet loss rate of the plurality of QoS flows, or
an un-synchronization rate among transmissions of packets which belong to the same application data unit and are on different QoS flows.

In an embodiment, the correlation actions performed by the second wireless network node comprises reporting at least one QoS event (e.g., reporting Average Packet Delay/Packet Loss Rate of QoS flows, Deviation of Packet Delay/Packet Loss Rate of QoS flows, and/or Un-synchronize Rate, etc.) associated with the ADU.

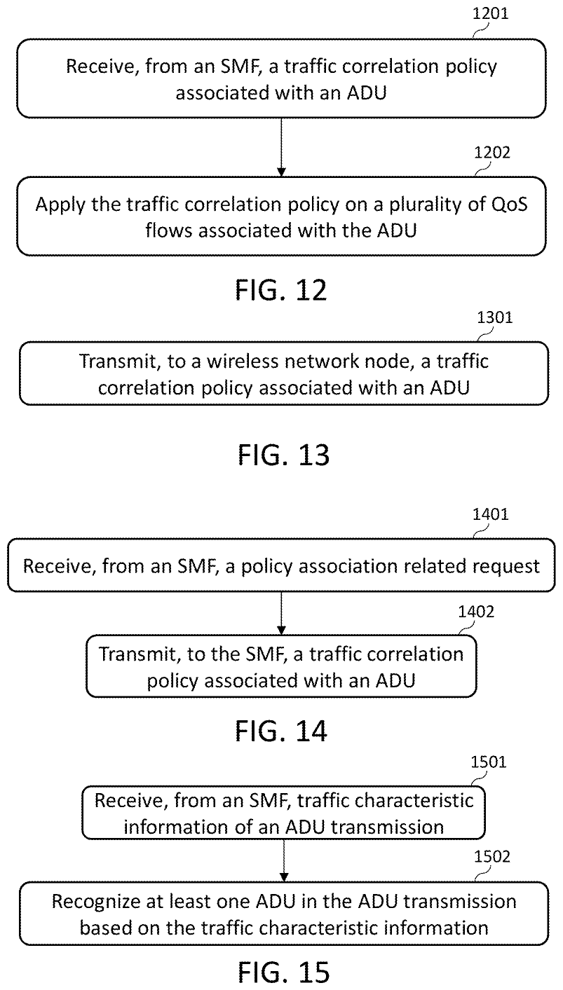

FIG. 12 shows a flowchart of a method according to an embodiment of the present disclosure. The method shown in FIG. 12 may be used in a wireless network node (e.g., UPF, RAN, a wireless network node comprising the UPF or RAN, a wireless network node performing at least part of functionalities of UPF or RAN) and comprises:

Step 1201: Receive, from an SMF, a traffic correlation policy associated with an ADU.

Step 1202: Apply the traffic correlation policy on a plurality of QoS flows associated with the ADU.

In FIG. 12, the wireless network node receives a traffic correlation policy associated with an ADU. The ADU comprises (overlapped) packets transmitted on different QoS flows. The wireless network node applies the traffic correlation policy on the plurality of QoS flows associated with the ADU (i.e., the QoS flows on which the packets/data traffic of the ADU is transmitted).

In an embodiment, the traffic correlation policy comprises at least one of:
a correlation policy ID,
a list of QoS flows,
a list of QoS monitoring actions,
a list of event report thresholds, or
a list of event report triggers.

Specifically, the correlation policy ID may be configured to indicate the applied correlation policy. The list of QoS flows may be configured to indicate the related QoS flows.

In an embodiment, the list of QoS monitoring actions comprises at least one of:
monitoring a packet delay of the plurality of QoS flows,
monitoring a packet loss rate of the plurality of QoS flows, or
monitoring an un-synchronization rate among transmissions of packets which belong to the same application data unit and are on different QoS flows.

In an embodiment, the list of event report thresholds is associated with at least one of:
an average packet delay of the plurality of QoS flows,
a deviation of packet delay of the plurality of QoS flows,
an average packet loss rate of the plurality of QoS flows,
a deviation of packet loss rate of the plurality of QoS flows, or
an un-synchronization rate among transmissions of packets which belong to the same application data unit and are on different QoS flows.

In an embodiment, the list of event report triggers comprises reporting at least one of:
an average packet delay of the plurality of QoS flows,
a deviation of packet delay of the plurality of QoS flows,
an average packet loss rate of the plurality of QoS flows,
a deviation of packet loss rate of the plurality of QoS flows, or
an un-synchronization rate among transmissions of packets which belong to the same application data unit and are on different QoS flows.

In an embodiment, the wireless network node may further receive traffic characteristic information of ADU transmission (e.g., transmission of one or more ADUs) to the wireless network node. The traffic characteristic information is used to identify/recognize (the data traffic/packets of) the ADU transmission.

In an embodiment, the traffic characteristic information comprises at least one of:
a list of QoS flows,
at least one precentor QoS flow identifier associated with at least one precentor QoS flow on which the first data block (e.g., packet) in the application data unit transmission is transmitted,
a precentor transmission pattern of the first data block transmitted on the at least one precentor QoS flow,
a maximum size of single ADU in the ADU transmission,
a maximum duration of the ADU transmission, or
an ADU transmission pattern of the ADU transmission.

In an embodiment, the ADU transmission pattern comprises at least one of:
a duration of the ADU transmission,
a size of single ADU in the ADU transmission, or
an interval between two subsequent ADUs in the ADU transmission.

Based on the traffic characteristic information, the wireless network node is able to recognize/detect the ADU transmissions (i.e., one or more ADUs) and perform corresponding actions on the recognized/detected ADU(s). For example, the wireless network node may perform at least one of:
transmitting a packet of one of the ADU(s), wherein a header of the packet comprises traffic correlation information associated with the ADU to which the packet belongs,
applying a traffic correlation polity on the ADU transmission,
acquiring at least one measurement result associated with the ADU transmission,
monitoring at least one QoS measurement result associated with the ADU transmission, or
reporting at least one QoS event associated with the ADU transmission.

Detail of these actions may be referred to the above embodiments and is not described herein for brevity.

FIG. 13 shows a flowchart of a method according to an embodiment of the present disclosure. The method shown in FIG. 13 may be used in an SMF (e.g., wireless network node/wireless device comprising the SMF or wireless network node/wireless device performing at least part of functionalities of the SMF) and comprises:

Step 1301: Transmit, to a wireless network node, a traffic correlation policy associated with an ADU.

In FIG. 13, the SMF transmits a traffic correlation policy associated with an ADU to a wireless network node (e.g., UPF or RAN). The traffic correlation policy is applied on a plurality of QoS flows associated with the ADU (i.e., the QoS flows on which the packets/data traffic of the ADU is transmitted)

The detail of the traffic correlation policy can be referred to the aforementioned embodiments.

In an embodiment, the SMF may further transmit traffic characteristic information of ADU transmission (e.g., transmission of one or more ADUs) to the wireless network node. The traffic characteristic information is used to identify/recognize (the data traffic/packets of) the ADU transmission. The detail of the traffic characteristic information can be referred to the aforementioned embodiments.

In an embodiment, the traffic correlation policy and/or the traffic characteristic information is received from the PCF. For example, the SMF may transmit a policy associated related request to the PCF, for acquiring the traffic correlation policy and/or the traffic characteristic information.

FIG. 14 shows a flowchart of a method according to an embodiment of the present disclosure. The method shown in FIG. 14 may be used in a PCF (wireless network node/wireless device comprising the PCF or wireless network node/wireless device performing at least part of functionalities of the PCF) and comprises:

Step 1401: Receive, from an SMF, a policy association related request.

Step 1402: Transmit, to the SMF, a traffic correlation policy associated with an ADU.

In this embodiment, the PCF receives policy association related request (associated with the UE). The PCF transmits a traffic correlation policy associated with an ADU to the SMF.

In an embodiment, the PCF may further transmit traffic characteristic information of ADU transmission to the SMF.

The detail of the traffic characteristic policy and the traffic characteristic information can be referred to the aforementioned embodiments.

FIG. 15 shows a flowchart of a method according to an embodiment of the present disclosure. The method shown in FIG. 15 may be used in a wireless network node (e.g., UPF, RAN, a wireless network node comprising the UPF or RAN, a wireless network node performing at least part of functionalities of UPF or RAN) and comprises:

Step 1501: Receive, from an SMF, traffic characteristic information of an ADU transmission.

Step 1502: Recognize at least one ADU in the ADU transmission based on the traffic characteristic information.

In this embodiment, the wireless network node receives traffic characteristic information of an ADU transmission (i.e., one or more ADUs) from an SMF. Based on the traffic characteristic information, the wireless network node is able to recognize/detect/identify the one or more ADUs. Note that, each ADU comprises packets/data traffic transmitted on a plurality of QoS flows.

The detail of the traffic characteristic information may be referred to aforementioned embodiments.

The wireless network node may perform further actions on (packets/data traffic of) the recognized ADUs. For example, the wireless network node may perform at least one of:
transmitting a packet of one of the ADU(s), wherein a header of the packet comprises traffic correlation information associated with the ADU to which the packet belongs,
applying a traffic correlation polity on the ADU transmission,
acquiring at least one measurement result associated with the ADU transmission,
monitoring at least one QoS measurement result associated with the ADU transmission, or
reporting at least one QoS event associated with the ADU transmission.

Detail of these actions may be referred to the above embodiments and is not described herein for brevity.

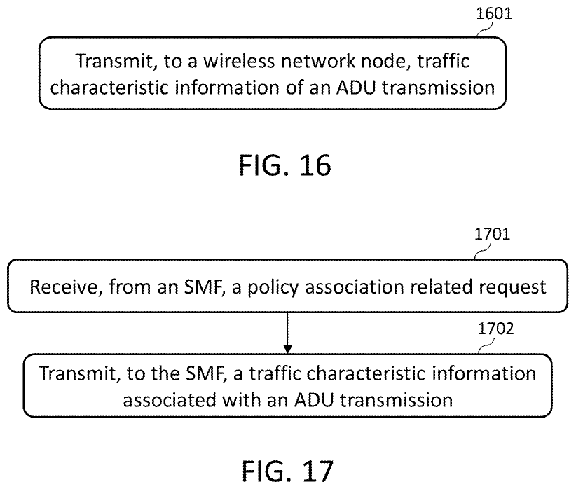

FIG. 16 shows a flowchart of a method according to an embodiment of the present disclosure. The method shown in FIG. 16 may be used in an SMF (e.g., wireless network node/wireless device comprising the SMF or wireless network node/wireless device performing at least part of functionalities of the SMF) and comprises:

Step 1601: Transmit, to a wireless network node, traffic characteristic information of an ADU transmission.

In FIG. 16, the SMF transmits traffic characteristic information of an ADU transmission (i.e., one or more ADUs) to the wireless network node (e.g., UPF/RAN). The traffic characteristic information is used to detect/identify/recognize the ADU transmission.

The detail of the traffic characteristic information may be referred to aforementioned embodiments.

In an embodiment, the traffic characteristic information is received from the PCF. For example, the SMF may transmit a policy associated related request to the PCF, for acquiring the traffic characteristic information.

FIG. 17 shows a flowchart of a method according to an embodiment of the present disclosure. The method shown in FIG. 17 may be used in a PCF (wireless network node/wireless device comprising the PCF or wireless network node/wireless device performing at least part of functionalities of the PCF) and comprises:

Step 1701: Receive, from an SMF, a policy association related request.

Step 1702: Transmit, to the SMF, a traffic characteristic information associated with an ADU transmission.

In this embodiment, the PCF receives policy association related request (associated with the UE) and transmits traffic characteristic information associated with an ADU transmission (i.e., one or more ADUs) to the SMF. The traffic characteristic information is used to detect/identify/recognize the ADU transmission.

The detail of the traffic characteristic information can be referred to the aforementioned embodiments.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand example features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described example embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according to embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of the claims. Thus, the disclosure is not intended to be limited to the implementations shown herein, but is to be accorded the widest scope consistent with the novel features and principles disclosed herein, as recited in the claims below.

1. A wireless communication method for use in a first wireless network node, the wireless communication method comprising:
transmitting, to a second wireless network node, a packet in a quality of service (QOS) flow associated with an application data unit,
wherein a packet header of the packet comprises traffic correlation information associated with the application data unit.

2. The wireless communication method of claim 1, wherein the traffic correlation information comprises a traffic correlation identifier of the application data unit.

3. The wireless communication method of claim 2, wherein the traffic correlation identifier indicates at least one of:
a correlation policy identifier associated with a correlation policy applied on a plurality of QoS flows,
an application data unit type associated with a type of the application data unit,
an application type associated with a type of an application to which the packet belongs, or
an application identifier associated with the application to which the packet belongs.

4. The wireless communication method of claim 1, wherein the traffic correlation information comprises information associated with at least one of:
a sequence number of the application data unit,
a size of the application data unit,
an importance level of the packet in the application data unit, or
a duplication number of the application data unit.

5. The wireless communication method of any of claim 1, wherein the first wireless network node is one of a user plane function and a radio access network node.

6. The wireless communication method of claim 1, wherein the packet is a general packet radio service tunneling protocol user plane (GTP-U) packet and the packet header is a GTP-U header.

7. A wireless communication method for use in a second wireless network node, the wireless communication method comprising:
receiving, from a first wireless network node, a packet in a quality of service (QOS) flow associated with an application data unit, wherein a packet header of the packet comprises traffic correlation information associated with the application data unit, and
performing a correlation action on the packet based on the traffic correlation information.

8. The wireless communication method of claim 7, wherein the traffic correlation information comprises a traffic correlation identifier of the application data unit.

9. The wireless communication method of claim 8, wherein the traffic correlation identifier indicates at least one of:
a correlation policy identifier associated with a correlation policy applied on a plurality of QoS flows,
an application data unit type associated with a type of the application data unit,
an application type associated with a type of an application to which the packet belongs, or
an application identifier associated with the application to which the packet belongs.

10. The wireless communication method of claim 7, wherein the traffic correlation information comprises information associated with at least one of:
a sequence number of the application data unit,
a size of the application data unit,
an importance level of the packet in the application data unit, or
a duplication number of the application data unit.

11. The wireless communication method of claim 7, wherein the second wireless network node is one of a user plane function and a radio access network node.

12. The wireless communication method of claim 7, wherein the packet is a general packet radio service tunneling protocol user plane (GTP-U) packet and the packet header is a GTP-U header.

13. The wireless communication method of claim 7, wherein performing the correlation action on the packet based on the traffic correlation information comprises:
associating the packet with the application data unit based on the traffic correlation information.

14. The wireless communication method of claim 7, wherein performing the correlation action on the packet based on the traffic correlation information comprises:
applying a correlation policy associated with the application data unit based on the traffic correlation information.

15. The wireless communication method of claim 7, wherein performing the correlation action on the packet based on the traffic correlation information comprises:
acquiring at least one measurement result of the application data unit based on the traffic correlation information.

16. The wireless communication method of claim 15, wherein the at least one measurement result comprises at least one of:
an average packet delay of a plurality of QoS flows,
a deviation of packet delay of a plurality of QoS flows,
an average packet loss rate of a plurality of QoS flows,
a deviation of packet loss rate of a plurality of QoS flows, or
an un-synchronization rate among transmissions of packets which belong to the same application data unit and are on different QoS flows.

17. The wireless communication method of claim 7, wherein performing the correlation action on the packet based on the traffic correlation information comprises:
reporting at least one QoS event associated with the application data unit.

18. A first wireless network node, comprising:
a communication unit, configured to transmit, to a second wireless network node, a packet in a quality of service (QOS) flow associated with an application data unit, wherein a packet header of the packet comprises traffic correlation information associated with the application data unit.

19. A second wireless network node, comprising:
a communication unit, configured to receive, from a first wireless network node, a packet in a quality of service (QOS) flow associated with an application data unit, wherein a packet header of the packet comprises traffic correlation information associated with the application data unit, and
at least one processor, configured to perform a correlation action on the packet based on the traffic correlation information.

20. A non-transitory computer-readable program medium having code stored thereupon, the code, when executed by at least one processor, causing the at least one processor to implement a wireless communication method recited in claim 1.
